(19) United States
(12) Patent Application Publication
(10) Pub. No.: US 2011/0011776 A1
(43) Pub. Date: Jan. 20, 2011

(54) CLASSIFYING APPARATUS AND METHOD

(75) Inventors: Kazuya HONGO, Kanagawa (JP); Tetsuo OHTA, Kanagawa (JP); Hiroshi KOJIMA, Kanagawa (JP); Seiichi TAKAGI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/699,567

(22) Filed: Feb. 3, 2010

(30) Foreign Application Priority Data
Jul. 14, 2009 (JP) 2009-165527

(51) Int. Cl. B03B 5/62

(52) U.S. Cl. 209/157; 209/155

(57) ABSTRACT

A classifying apparatus includes: a classifying channel that, in an upper portion, has a channel through which a particle dispersion is transported, and that, in a lower portion, has a channel through which transporting liquid is transported; a particle dispersion introducing channel where one end has an opening into which the particle dispersion is introduced, and another end is connected to the channel through which the particle dispersion is transported; a transporting liquid introducing channel where one end has an opening into which the transporting liquid is introduced, and another end is connected to the channel through which the transporting liquid is transported; and at least one recovery channel as defined herein, a channel width of the channel through which the particle dispersion is transported being smaller than a channel width of the channel through which the transporting liquid is transported, in the classifying channel.

### CROSS-REFERENCE TO RELATED APPLICATIONS

This application is based on and claims priority under 35 USC 119 from Japanese Patent Application No. 2009-165527 filed on Jul. 14, 2009.

### BACKGROUND

### 1. Technical Field

The present invention relates to a classifying apparatus and a classifying method.

### SUMMARY

According to an aspect of the invention, there is provided a classifying apparatus having: a classifying channel that, in an upper portion, has a channel through which a particle dispersion is transported, and that, in a lower portion, has a channel through which transporting liquid is transported; a particle dispersion introducing channel where one end has an opening into which the particle dispersion is introduced, and another end is connected to the channel through which the particle dispersion is transported; a transporting liquid introducing channel where one end has an opening into which the transporting liquid is introduced, and another end is connected to the channel through which the transporting liquid is transported; and at least one recovery channel where one end has an opening, and another end is connected to the classifying channel to recover classified particles, a channel width of the channel through which the particle dispersion is transported being smaller than a channel width of the channel through which the transporting liquid is transported, in the classifying channel.

### BRIEF DESCRIPTION OF THE DRAWINGS

Exemplary embodiments of the present invention will be described in detail based on the following figures, wherein:

FIG. 1 is a perspective view showing an example of a classifying apparatus of an exemplary embodiment;

FIG. 2 is a sectional view of a channel showing a section taken along X-X′ in FIG. 1;

FIG. 3 is a Y-Y′ sectional view of the classifying apparatus shown in FIG. 1;

FIG. 4 is a perspective view showing an example of a conventional classifying apparatus 100;

FIG. 5 is a schematic perspective view showing another example of the classifying apparatus of the exemplary embodiment;

FIGS. 6A and 6B are sectional views of a channel showing another embodiment of the classifying apparatus;

FIG. 7 is a schematic perspective view showing another embodiment of the classifying apparatus of the exemplary embodiment;

FIG. 8 is an example of a diagram of a system configuration in which the classifying apparatus of the exemplary embodiment is used;

FIG. 9 is another example of a diagram of a system configuration in which the classifying apparatus of the exemplary embodiment is used;

FIG. 10 is an example of a configuration diagram of a classifying system in which the classifying apparatus shown in FIG. 7 is used;

FIG. 11 is a dimension view showing a classifying apparatus used in Example 1;

FIG. 12 is a dimension view showing a classifying apparatus used in Example 2; and

FIG. 13 is a dimension view showing a classifying apparatus used in Comparative example 1.

### DESCRIPTION OF REFERENCE NUMERALS AND SIGNS

100 classifying apparatus
110 classifying channel
112 channel
114 transporting liquid channel
120 particle dispersion introducing channel
130 transporting liquid introducing channel
140 recovery channel
141 recovery channel
180 stirrer
181 stirring element
S transporting liquid
R particle dispersion
T₁ coarse powder recovery liquid
T₂ fine powder recovery liquid

### DETAILED DESCRIPTION

The classifying apparatus of the invention is characterized in that the apparatus has: a classifying channel that, in an upper portion, has a channel through which a particle dispersion is transported, and that, in a lower portion, has a channel (hereinafter, also referred to as “transporting liquid channel) through which transporting liquid is transported; a particle dispersion introducing channel where one end has an opening into which the particle dispersion is introduced, and the other end is connected to the channel; a transporting liquid introducing channel where one end has an opening into which the transporting liquid is introduced, and the other end is connected to the channel through which the transporting liquid is transported; and at least one recovery channel where one end has an opening, and the other end is connected to the classifying channel to recover classified particles, and the channel width of the channel is smaller than that of the channel through which the transporting liquid is transported, in the classifying channel.

In the following description, unless otherwise specified, the term “A to B” indicating a numerical range means “equal to or larger than A and equal to or smaller than B”. Namely, the term means a numerical range including A and B which are the end points.

Hereinafter, the apparatus will be described in further detail with reference to the drawings. In the following description, unless otherwise specified, the same reference numerals denote identical components.

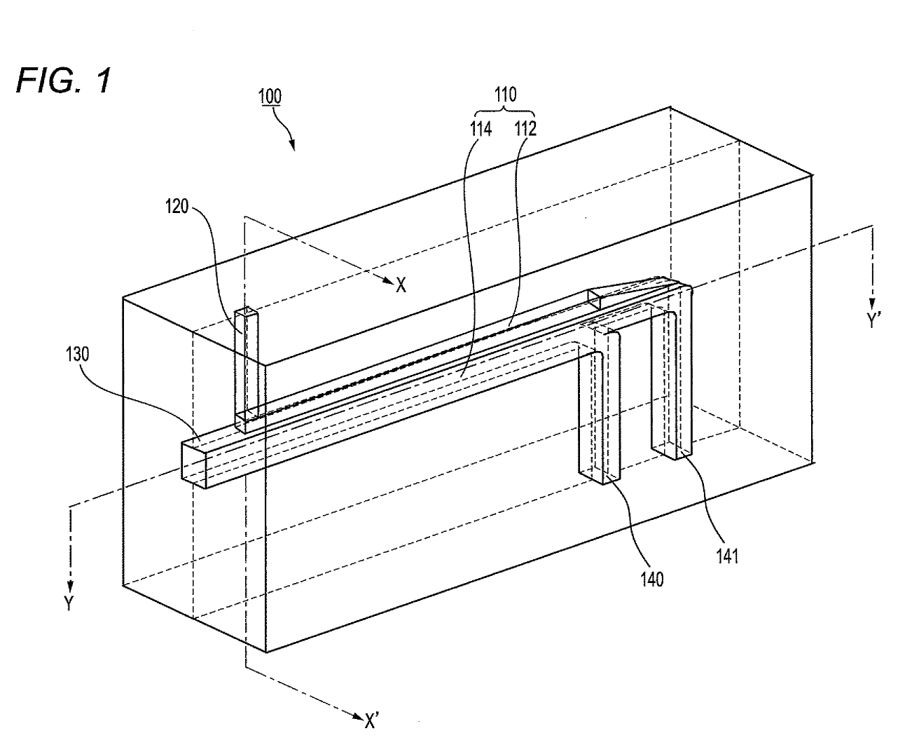

FIG. 1 is a schematic perspective view showing an example of the classifying apparatus of the exemplary embodiment.

The classifying apparatus 100 shown in FIG. 1 has a classifying channel 110 that, in an upper portion, has a channel 112 through which the particle dispersion is flown, and that, in a lower portion, has a channel (transporting liquid channel) 114 through which the transporting liquid is transported. In the upstream side of the classifying channel 110, a particle dispersion introducing channel 120 where one end has an opening into which the particle dispersion is introduced, and the other end is connected to the channel 112, and a transporting liquid introducing channel 130 where one end has an opening into which the transporting liquid is introduced, and the other end is connected to the channel (transporting liquid channel) 114 through which the transporting liquid is transported are placed.

In the classifying channel 110, the particle dispersion and the transporting liquid are transported under a laminar flow in which the particle dispersion is in the upper layer, and the transporting liquid is in the lower layer. The particle dispersion is transported through the channel 112 which is disposed on the upper side (the upper portion) of the classifying channel 110 in the vertical direction. By contrast, the transporting liquid is transported through the transporting liquid channel 114 which is positioned on the lower side (the lower portion) of the channel 112 in the vertical direction. Particles in the particle dispersion in the particle dispersion are sedimented by gravity during when the particle dispersion is transported through the classifying channel 110. At this time, when particles contained in the particle dispersion have the same specific gravity, lager particles are first sedimented by Stokes' definition, and small particles are transported toward the downstream of the classifying channel 110 while being slowly sedimented. In the downstream side of the classifying channel 110, at least one recovery channel 140 where one end has an opening, and the other end is connected to the classifying channel to recover classified particles is disposed. In FIG. 1, two recovery channels 140, 141 are disposed. However, the exemplary embodiment is not restricted to this. It is required to dispose at least one recovery channel. Preferably, two or more recovery channels are disposed.

Referring to FIG. 1, the particle dispersion transported from the particle dispersion introducing channel 120 is transported to the channel 112, and the transporting liquid transported from the transporting liquid introducing channel 130 is transported to the transporting liquid channel 114. In the exemplary embodiment, the channel width of the channel 112 is smaller than that of the transporting liquid channel 114.

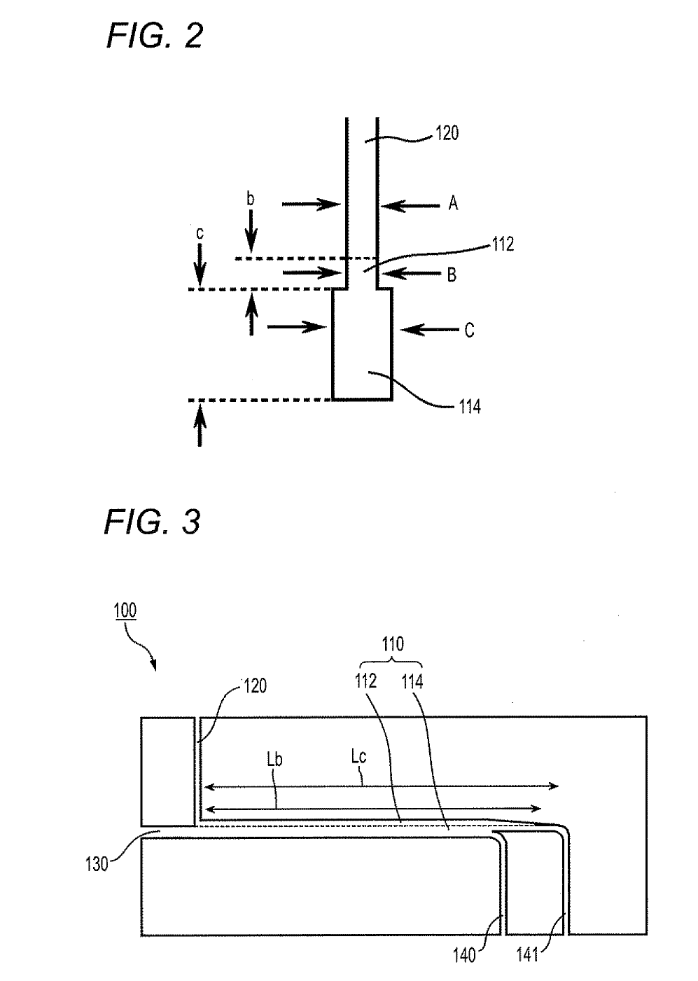

FIG. 2 is a sectional view of a channel showing a section taken along X-X′ in FIG. 1. In FIG. 2, the channel widths of the particle dispersion introducing channel 120, the channel 112, and the transporting liquid channel 114 are indicated by A, B, and C, respectively.

In the exemplary embodiment, B<C holds.

It is required that B<C holds in a part of the classifying channel 110. Preferably, B<C holds at least in the most upstream of the channel 112. In a specific example of this configuration, B<C is set in the upstream of the classifying channel 110, then the channel width B of the channel 112 is gradually widened, and B=C is set in the vicinity of the recovery channel 140. In the exemplary embodiment, preferably, B<C is set over the whole classifying channel 110.

In the exemplary embodiment, the channel width C of the transporting liquid channel 114 means the length in a direction perpendicular to the flowing direction of the fluid, and in the horizontal direction. Preferably, the channel width is 15 to 3,000 μm, more preferably, 20 to 1,500 μm, and, still more preferably, 30 to 1,400 μm. When the channel width of the transporting liquid channel is within the above range, the particle dispersion and the transporting liquid are stably transported under a laminar flow, and therefore the range is preferred. Since clogging by particles which are sedimented from the channel into the transporting liquid channel hardly occurs, the range is preferred.

The channel height (in FIG. 2, indicated by c) of the transporting liquid channel 114 is not particularly restricted, and, preferably, is 15 to 10,000 μm, more preferably, 20 to 7,000 μm, and, still more preferably, 30 to 5,000 μm. When the channel height of the transporting liquid channel is within the above range, clogging of the channel hardly occurs, and hence the range is preferred.

The channel width B of the channel 112 means the length in a direction perpendicular to the flowing direction of the fluid, and in the horizontal direction. The channel width is not particularly restricted as far as the channel width is smaller than the channel width C of the transporting liquid channel 114, preferably, about 1 to about 2,500 μm, more preferably, about 5 to about 2,000 μm, and, still more preferably, about 10 to about 1,500 μm.

Preferably, the channel width B is smaller than the channel width C, and equal to or smaller than about ⅔ of the channel width C, more preferably, about 1/100 to about 60/100 of the channel width C, and, still more preferably, about 5/100 to about 55/100 of the channel width C. When the channel width B is equal to or larger than the channel width C, the sedimentation of particles from the channel into the transporting liquid channel is not suppressed, and the classification accuracy is improved.

The channel height (in FIG. 2, indicated by b) of the channel 112 is not particularly restricted, preferably, is about 1 to about 2,000 μm, more preferably, about 5 to about 1,700 μm, and, still more preferably, about 10 to about 1,500 μm. When the channel height of the channel is within the above range, it is possible to obtain a high classification efficiency, and hence the range is preferred.

In the exemplary embodiment, when the channel width of the particle dispersion introducing channel 120 is indicated by A, it is preferable that A, B, and C satisfy following Expression (1):

A≦B<C (1).

In the configuration where the channel width A of the particle dispersion introducing channel 120 is equal to or smaller than the channel width B of the channel 112, even in the case where the content of particles in the particle dispersion is high, clogging by particles hardly occurs, the particle dispersion can be uniformly transported, and transportation of particles is not blocked. Therefore the configuration is preferred.

The channel width A of the particle dispersion introducing channel 120 means the length in a direction along which the particle dispersion introducing channel 120 is orthogonal to the flowing direction of the fluid in the channel 112, and, preferably, is 1 to 2,000 μm, more preferably, 5 to 1,700 μm, and, still more preferably, 10 to 1,500 μm.

Preferably, the channel width A of the particle dispersion introducing channel 120 is about 0.1 to about 1 time of the channel width B of the channel 112, more preferably, about 0.15 to about 0.95 times of the channel width B, and, still more preferably, about 0.2 to about 0.9 times of the channel width B.

FIG. 3 is a Y-Y′ sectional view of the classifying apparatus shown in FIG. 1. In FIG. 3, the length (the length in the flowing direction) of the channel 112 is indicated by Lb, and the length (the length in the flowing direction) of the transporting liquid channel 114 is indicated by Lc.

In the exemplary embodiment, preferably, Lb and Lc satisfy following Expression (2):

0.1×Lc≦Lb≦Lc (2).

In the above expression, Lc means the channel length in the range from the place where the transporting liquid and the particle dispersion join together, to the most downstream recovery channel. Even in the case where the channel is tapered as shown in FIGS. 1 and 3, Lb means the whole length of the channel including the tapered portion.

When Lb is equal to or lager than 0.1×Lc and equal to or smaller than Lc, it is possible to obtain a high classification efficiency, and hence this is preferred.

Preferably, Lb is about 0.15 to about 0.95 times of Lc, more preferably, about 0.2 to about 0.9 times of Lc, and, still more preferably, about 0.25 to about 0.85 times of Lc.

Next, the estimation mechanism in the exemplary embodiment will be described while comparing with the prior art.

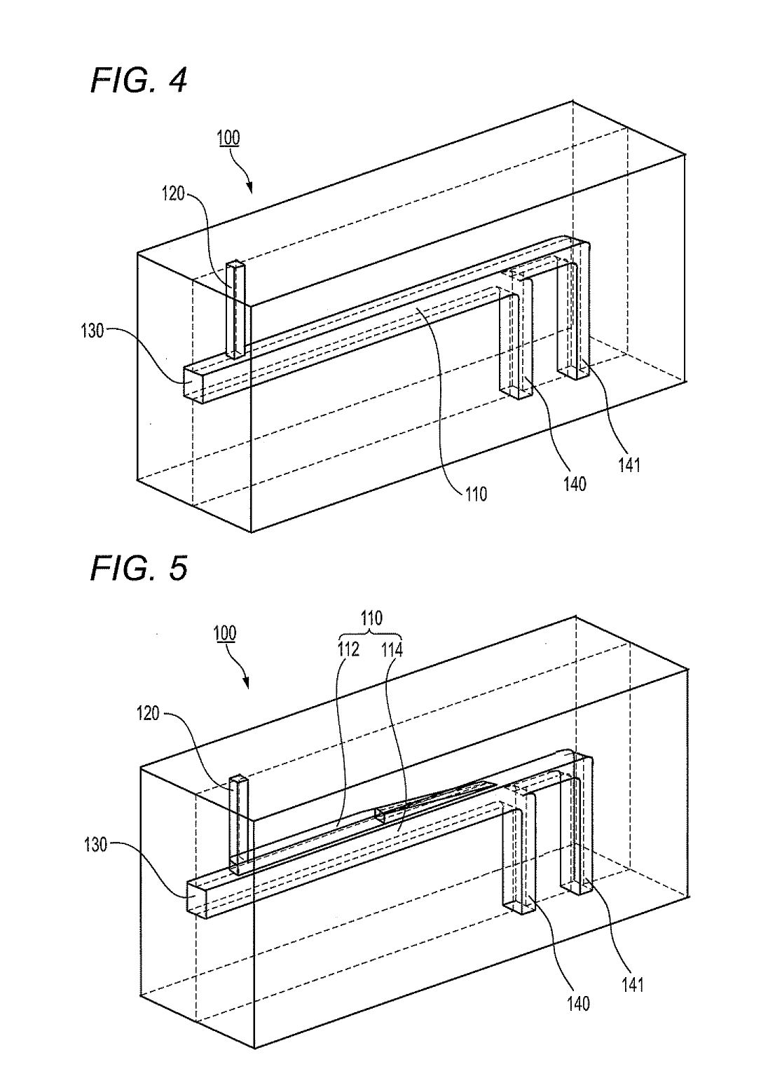

FIG. 4 is a perspective view showing an example of a conventional classifying apparatus 100 in which a channel is not disposed. Referring to FIG. 4, the particle dispersion introducing channel 120 where one ends has an opening, and the transporting liquid introducing channel 130 where one ends has an opening are connected to the classifying channel 110. The particle dispersion is transported through the upper portion of the classifying channel 110, and the transporting liquid is transported through the lower portion.

The inventors have found that, in the case where a particle dispersion having a relatively high concentration is introduced into the classifying apparatus shown in FIG. 4, in accordance with sedimentation of particles, a flow (hereinafter, sometimes referred to as “replacement flow”) in which a solvent tries to enter the space where the particles have existed is produced in a downward direction, and, as a result, the replacement flow is seemed to act as an external force in addition to the sedimentation of particles by gravity. As a result of intensive study conducted by the inventors, it has been found that, when particle dispersion is transported through the channel, an interface is formed between the transporting liquid and the particle dispersion, and the effect of the replacement flow is suppressed, thereby completing the invention. Furthermore, it is seemed that, as being further transported through the channel, the particle dispersion introduced from the particle dispersion introducing channel is gradually diluted, and therefore particles are slowly sedimented from the channel into the transporting liquid channel, so that, in the case where the concentration of the particle dispersion is high, particularly, the sedimentation speed can be prevented from being rapidly raised.

In the classifying apparatus of the exemplary embodiment, preferably, all of the classifying channel, the particle dispersion introducing channel, the transporting liquid introducing channel, and the recovery channels are microchannels. Preferably, the classifying apparatus of the exemplary embodiment is an apparatus having a plurality of microscale channels.

In a microscale channel, both the dimensions and the flow rate are small. In the exemplary embodiment, the Reynolds number is 2,300 or less. Therefore, the classifying apparatus of the exemplary embodiment is not an apparatus in which a turbulent flow is predominant as in a usual classifying apparatus, but an apparatus in which a laminar flow is predominant.

The Reynolds number (Re) is indicated by the following expression:

Re=uL/ν

(u: flow rate, L: characteristic length, and ν: kinematic viscosity coefficient).
When the number is 2,300 or less, a laminar flow is predominant.

In an apparatus in which a laminar flow is predominant as described above, in the case where particles in particle dispersion are heavier than a medium liquid which is a dispersion medium, the fine particles are sedimented in the medium liquid. The sedimentation speed is varied depending on the specific gravity or size of the fine particles. In the exemplary embodiment, the difference in sedimentation speed is used for the classification of the particles. In the case where the particles have different particle sizes, particularly, the sedimentation speed is proportional to a square value of the particle size. As the size of the particles is larger, the particles are faster sedimented.

Therefore, the exemplary embodiment is suitable for classifying particles of different particle sizes.

By contrast, in the case where the channel has a large diameter and the particle dispersion forms a turbulent flow, the position where particles are sedimented is varied. In the case, therefore, classification is basically impossible.

FIG. 5 is a schematic perspective view showing another example of the classifying apparatus of the exemplary embodiment.

The classifying apparatus 100 shown in FIG. 5 is identical in basic configuration with the classifying apparatus 100 shown in FIG. 1, except that the channel 112 is shorter than that of the classifying apparatus 100 shown in FIG. 1.

As shown in FIG. 5, in the exemplary embodiment, the length of the channel 112 can be suitably selected. As described above, preferably, the length Lb of the channel 112 is 0.1 to 1 time of the length Lc of the transporting liquid channel 114. In the classifying apparatuses 100 shown in FIGS. 1 and 5, the downstream side of the channel 112 is tapered. The exemplary embodiment is not restricted to this. Specifically, as in a classifying apparatus 100 which is shown in FIG. 7, and which is described later, the channel 112 may have a shape in which the terminal end is not tapered. Among these shapes, a shape in which the vicinity of the downstream terminal end of the channel 112 is tapered is preferred from the viewpoint of suppressing clogging by particles and particle stagnation.

The lengths of the channel and the transporting liquid channel may be adequately selected in consideration of the easiness of classification of particles which are to be classified, and, for example, the distribution of the particles, and the difference in specific gravity between the medium liquid (the dispersion medium of the particle dispersion) and the particles, and the like.

In the case where the difference in specific gravity between the medium liquid and the transporting liquid, and particles is small, usually, it is preferred to prolong the lengths of the channel and the transporting liquid channel.

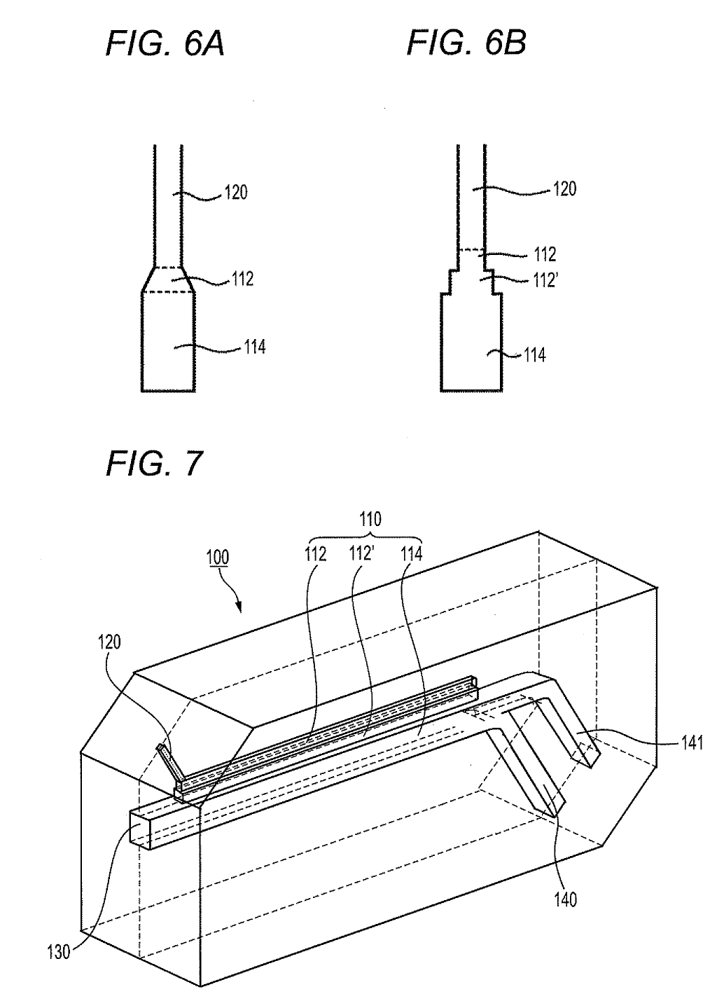

FIGS. 6A and 6B are sectional views of a channel showing another embodiment of the classifying apparatus 100. FIGS. 6A and 6B are sectional views similar to that of FIG. 2.

When compared with FIG. 2, the classifying channel 110 in FIG. 6A has the channel 112 in an upper portion, and the transporting liquid channel 114 in a lower portion. The channel 112 has a section shape which is widened in a taper-like manner with starting from the ceiling face.

In the case where the channel width of the channel 112 is not constant as shown in FIG. 6A, the channel width is the average value of channel widths in the range from the ceiling face of the channel to the inner bottom face. Namely, in the case where the channel is tapered as shown in FIG. 6A, the intermediate value of the channel widths of the ceiling face of the channel and the inner bottom face is set as the channel width.

Preferably, the classifying channel 110 has a shape in which the channel width is constant in the range between the ceiling face and the bottom face (the section has a rectangular shape), or that in which the channel width is more increased as further advancing from the ceiling face to the bottom face (a tapered shape, the section has a trapezoidal shape). In the case where the section shape is trapezoidal (a tapered shape), preferably, the channel width is more increased as further advancing from the ceiling face to the bottom face, and the channel width of the bottom face of the channel is set to be equal to or smaller than that of the ceiling face of the transported liquid channel. When the channel width of the bottom face of the channel is equal to or smaller than that of the ceiling face of the transported liquid channel, the occurrence of particle stagnation is suppressed. Therefore, this configuration is preferred.

In the exemplary embodiment, the section shapes of the all channels are not particularly restricted, and may be any of, for example, rectangular, trapezoidal, and circular shapes. From the viewpoint of the facility of working, a rectangular shape is preferred.

FIG. 7 is a schematic perspective view showing another embodiment of the classifying apparatus 100 of the exemplary embodiment.

FIG. 6B is a sectional view which shows a channel in the classifying apparatus shown in FIG. 7, and which is similar to FIG. 2.

As shown in FIG. 7, the exemplary embodiment may have a configuration in which the channel has a step-like section shape, and the channel width is gradually widened. In FIG. 7, the channel has a two-step shape, and, when the steps are counted in the direction from the upper side in the vertical direction toward the downward, the channel width of the second channel 112′ is larger than that of the first channel 112. In FIG. 7, two channels, or the upper channel 112 and the lower channel 112′ are disposed.

In the embodiment, preferably, the channel has a multi-step structure as shown in FIG. 7. When the steps are counted in the direction from the upper side in the vertical direction toward the downward, the channel width of the first-step channel is indicated by BI, that of the second-step channel is indicated by BII, and that of the n-th-step channel is indicated by Bn, preferably, the following is satisfied:

A≦BI<BII< . . . <Bn<C.

Namely, it is preferred that, as advancing from the upper channel toward the lower channel, the channel width is gradually widened. According to the configuration, the classification accuracy is improved. Therefore, the configuration is preferred.

Next, the system configuration of the classifying apparatus of the exemplary embodiment will be described.

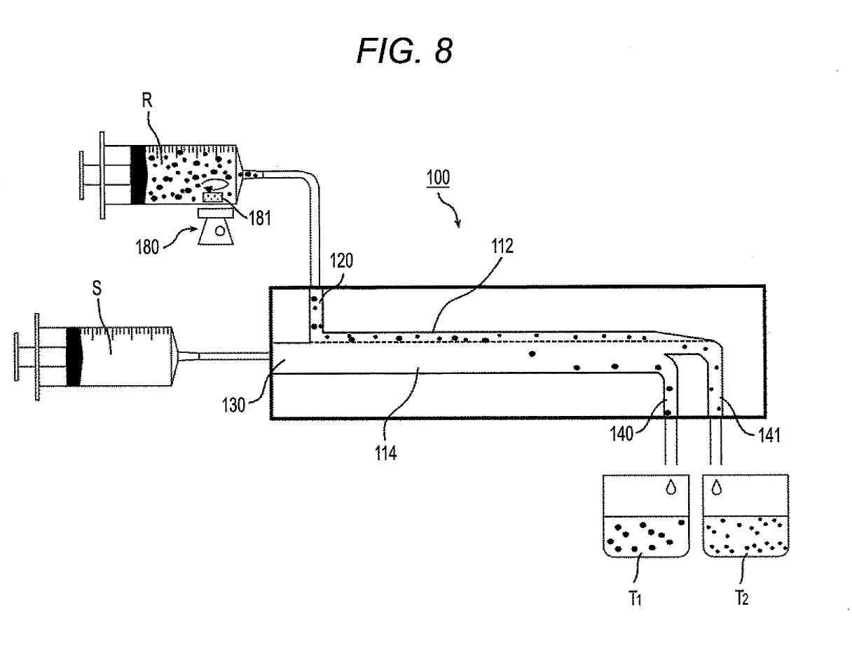

FIG. 8 is an example of a diagram of a system configuration in which the classifying apparatus of the exemplary embodiment is used. FIG. 8 is a diagram of a system in which the classifying apparatus shown in FIG. 1 is placed so that the liquid transportation direction in the classifying channel extends horizontally.

Referring to FIG. 8, a particle dispersion R is stored in a syringe in which a stirring element 181 is disposed. The stirring element 181 is rotated from the outside of the syringe by a stirrer 180, whereby the particle dispersion is transported in a uniform state. When a particle dispersion stands still, particles are sedimented, and it is difficult to transport a uniform particle dispersion. Therefore, it is preferable to transport a particle dispersion while performing stirring or the like.

Similarly, a transporting liquid S is stored in a syringe.

The particle dispersion R and the transporting liquid S are transported to the classifying apparatus 100 by a syringe pump (not shown).

In FIG. 8, the transportation direction of the transporting liquid S in the classifying apparatus 100 horizontally extends (in a horizontal direction which is 90° with respect to the vertical direction), and that of the particle dispersion R in the particle dispersion introducing channel 120 extends downward in the vertical direction. The transportation direction of the particle dispersion in the channel 112 horizontally extends.

Referring to FIG. 8, when a particle dispersion containing coarse particles and fine particles is transported through the channel, the coarse particles are sedimented faster than the fine particles, and hence the coarse particles are recovered by the recovery channel 140 which is disposed in the more upstream side. By contrast, the fine particles are slowly sedimented, and hence the fine particles are recovered by the recovery channel 141. Therefore, coarse powder recovery liquid (recovery liquid in which the content rate of the coarse component is higher than that of the transported particle dispersion) T₁ is recovered from the recovery channel 140, and fine powder recovery liquid (recovery liquid in which the content rate of the fine component is higher than that of the transported particle dispersion) T₂ is recovered from the recovery channel 141.

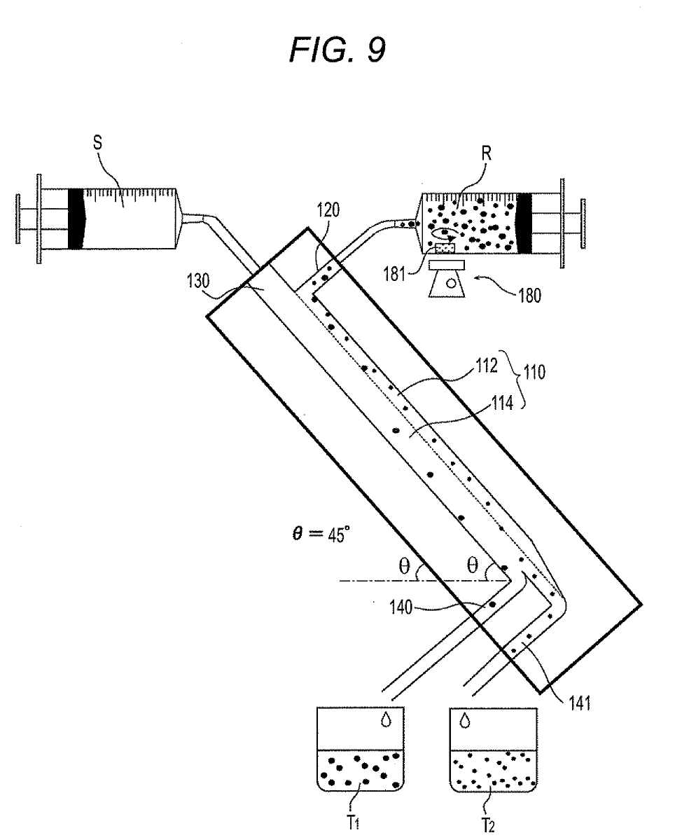

FIG. 9 is another example of a diagram of a system configuration in which the classifying apparatus of the exemplary embodiment is used.

In FIG. 9, the classifying channel shown in FIG. 8 is used while swung by an angle θ. In the exemplary embodiment, it is preferred to transport the liquid through the classifying channel from the upper side toward the lower side. In the case where the liquid is horizontally transported, particles which are sedimented in the classifying channel are sometimes deposited on the bottom face of the classifying channel. In a microchannel, particularly, the flow rate on the wall face is substantially zero, and particles are easily deposited.

By contrast, in the case where the bottom face of the classifying channel is inclined, particles which are sedimented on the bottom face of the classifying channel are downward moved along the bottom face by gravity. Therefore, deposition of particles and clogging of the channel due thereto are suppressed, and hence the configuration is preferred. In FIG. 9, the angle θ is set to 45°.

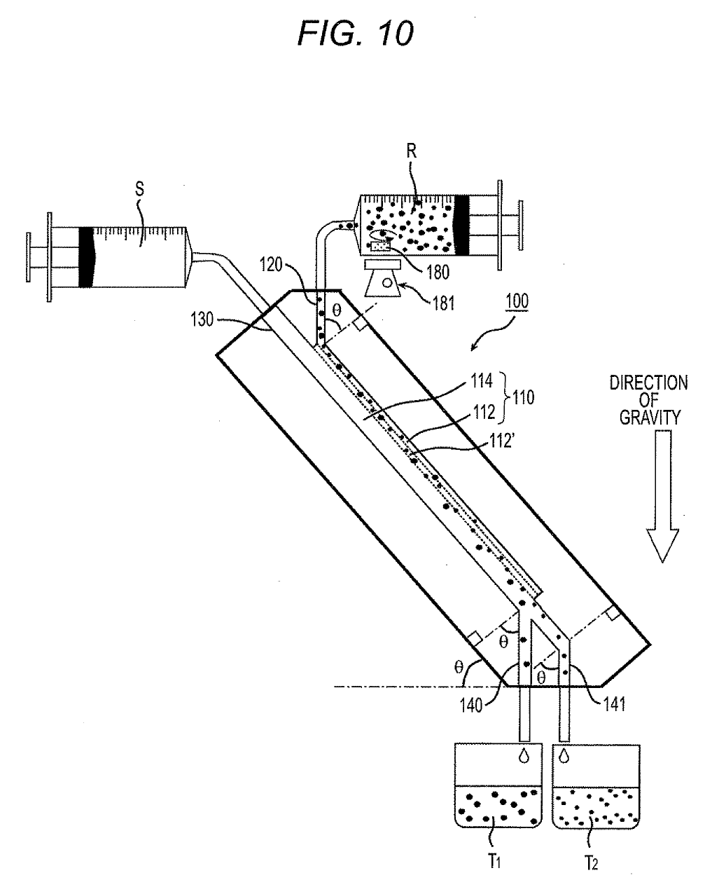

FIG. 10 is an example of a configuration diagram of a classifying system in which the classifying apparatus shown in FIG. 7 is used.

In FIG. 10, the transportation direction of the particle dispersion R in the particle dispersion introducing channel extends in a direction from the upper side in the vertical direction toward the lower side (hereinafter, the direction from the upper side in the vertical direction toward the lower side is sometimes referred to as the gravitational direction). Preferably, the transportation direction in the particle dispersion introducing channel is inclined from the horizontal direction, and the transportation is performed from the upper side toward the lower side, and, particularly preferably, in the gravitational direction. The situation where the angle of the transportation direction in a channel is horizontal is indicated by 0°, and that where the angle is in the gravitational direction is indicated by 90°. Preferably, the transportation direction in the particle dispersion introducing channel is larger than 0° and equal to or smaller than 135°, more preferably, 10 to 120°, and, still more preferably, 20 to 110°.

When the transportation direction in the particle dispersion introducing channel is larger than 0°, clogging by particles is suppressed. Therefore, the configuration is preferred. When the direction is 90°, particularly, clogging by particles most hardly occurs, and hence the configuration is preferred.

Preferably, the transportation direction in the classifying channel is larger than 0° and smaller than about 90°, more preferably, about 10 to about 80°, still more preferably, about 20 to about 70°, and, particularly preferably, about 30 to about 60°. When the transportation direction in the classifying channel is larger than 0°, particles which are sedimented on the bottom face of the classifying channel are downward moved along the bottom face by gravity as described above. Therefore, the configuration is preferred. When the transportation direction in the classifying channel is smaller than about 90°, the classification accuracy is improved. Therefore, the configuration is preferred.

In FIG. 10, the transportation directions in the recovery channels 140, 141 extend along the gravitational direction. Similarly with the transportation direction in the particle dispersion introducing channel, preferably, the transportation directions in the recovery channels are larger than 0° and equal to or smaller than 90°, more preferably, 10 to 90°, still more preferably, 20 to 90°, and, particularly preferably, 90° (the gravitational direction).

When the transportation directions in the recovery channels are set to the gravitational direction, clogging by particles is suppressed. Therefore, the configuration is particularly preferred.

In the exemplary embodiment, the transportation direction in the transporting liquid channel through which the transporting liquid not containing particles is transported is not particularly restricted.

The method of introducing the particle dispersion into the particle dispersion introducing channel, and that of introducing the transporting liquid into the transporting liquid introducing channel are not particularly restricted. Preferably, the liquid is pressingly introduced by microsyringes, rotary pumps, screw pumps, centrifugal pumps, piezopumps, gear pumps, Mohno pumps, plunger pumps, diaphragm pumps, or the like.

The flow rate of the particle dispersion in the particle dispersion introducing channel is preferably about 0.001 to about 500 mL/hr, and more preferably about 0.01 to about 300 mL/hr.

The flow rate of the transporting liquid in the transporting liquid introducing channel is preferably about 0.002 to about 5,000 mL/hr, and more preferably about 0.1 to about 3,000 mL/hr.

The material of the classifying apparatus is not particularly restricted, and may be selected from materials in general use, such as a metal, ceramic, plastic, glass, and the like. It is preferable that the material is appropriately selected depending on the medium to be transported, or the like.

The method of producing the classifying apparatus of the exemplary embodiment is not particularly restricted. The apparatus may be produced by any one of known methods.

The classifying apparatus of the exemplary embodiment may be produced on a solid substrate by the micro processing technique.

Examples of a material used as the solid substrate are a metal, silicon, teflon (registered trademark), glass, ceramic, plastic, and the like. Among the materials, a metal, silicon, teflon (registered trademark), glass, and ceramic are preferable from the viewpoints of heat resistance, pressure resistance, solvent resistance, and optical transparency, and, particularly preferably, glass.

An example of the micro processing technique for producing the channels is the method described in “Microreactor—Shinjidai no Gosei Gijyutsu—” (2003, published by CMC, supervised by YOSHIDA Junichi), “Bisai Kako Gijyutsu Oyohen—Photonics, Electronics, and Mechatronics keno Oyo—” (2003, published by NTS, edited by Kobunshi Gakkai Gyoji Iinkai), etc.

Representative methods are LIGA technology using X-ray lithography, high-aspect ratio photolithography using EPON SU-8, a microdischarge processing method (μ-EDM), a silicon high-aspect ratio processing method by Deep RIE, a Hot Emboss processing method, a photo-shaping method, a laser processing method, an ion beam processing method, a mechanical micro-cutting processing method using a micro-tool made of a hard material such as diamond, and the like. These technologies may be used alone or as combination thereof. Preferable micro processing technologies are LIGA technology using X-ray lithography, high-aspect ratio photolithography using EPON SU-8, a microdischarge processing method (μ-EDM), and a mechanical micro-cutting processing method.

The channels used in the exemplary embodiment can be produced also by employing a pattern formed by using a photoresist on a silicon wafer, as a mold, pouring a resin into the mold, and solidifying the resin (molding method). The molding method can use a silicone resin represented by polydimethylsiloxane (PDMS) or its derivative.

In Production of the classifying apparatus of the exemplary embodiment, it is possible to use a bonding technology. Usually, bonding technologies are roughly classified into solid phase bonding and liquid phase bonding. As a usual bonding method, pressure bonding and diffusion bonding are representative bonding methods in the solid phase bonding, and welding, eutectic bonding, soldering, adhesion, and the like are representative bonding methods in the liquid phase bonding.

In the bonding, furthermore, highly precise bonding method which does not involve destruction of a minute structure such as a channel by modification or deformation of a material due to high temperature heating, in which dimensional accuracy is maintained, and which is highly accurate is desirable. Examples of such a technology include silicon direct bonding, anode bonding, surface activation bonding, direct bonding using hydrogen bonding, bonding using HF aqueous solution, Au—Si eutectic bonding, and void-free adhesion.

The classifying apparatus of the exemplary embodiment may be formed by stacking pattern members (thin-film pattern members). Preferably, the pattern members have a thickness of 5 to 50 μm, and, more preferably, 10 to 30 μm. The classifying apparatus of the exemplary embodiment may be an apparatus that is formed by stacking pattern members in which a predetermined two-dimensional pattern is formed. The pattern members may be stacked in a state where the faces of the pattern members are directly contacted and bonded together.

An example of a producing method using a bonding technology is a producing method including:

(i) a step (donor substrate producing step) of forming a plurality of pattern members respectively corresponding to section shapes of the classifying apparatus to be produced, on a first substrate; and

(ii) a step (bonding step) of repeating bonding and separating processes on the first substrate on which the plurality of pattern members are formed, and a second substrate, whereby the plurality of pattern members on the first substrate are transferred to the second substrate.

For example, the producing method disclosed in JP-A-2006-187684 may be referred.

Next, the particle dispersion will be described. In the exemplary embodiment, the specific gravity of particles in the particle dispersion is larger than the specific gravities of the medium liquid which functions as a dispersion medium for the particle dispersion, and the transporting liquid.

In the particle dispersion, preferably, particles having a volume-average particle size of 0.1 to 1,000 μm are dispersed in the medium liquid, and the difference which is obtained by subtracting the specific gravity of the medium liquid from that of the particles is 0.01 to 20.

As the particles contained in the particle dispersion, any of resin particles, inorganic particles, metal particles, ceramic particles, and the like can be preferably used as far as the volume-average particle size is 0.1 to 1,000 μm.

Preferably, the volume-average particle size of the particles is 0.1 to 1,000 μm, more preferably, 0.1 to 500 μm, still more preferably, 0.1 to 200 μm, and, particularly preferably, 0.1 to 50 μm. When the volume-average particle size of the particles is equal to or smaller than 1,000 μm, clogging of the channel hardly occurs, and hence this is preferred. Moreover, the sedimentation speed is adequate, deposition on the bottom face of the channel and blocking of the channel are suppressed, and hence this is preferred. When the volume-average particle size of the particles is equal to or larger than 0.1 μm, interaction with respect to the inner wall face of the channel hardly occurs so that adhesion hardly occurs, and hence this is preferred.

The shape of the particles is not particularly restricted. When the particles have a needle form and in particular the long axis thereof is larger than ¼ of the channel width, however, the possibility that clogging of the channel occurs becomes high. From this viewpoint, a ratio (the long axis length/the short axis length) of the long axis length of the particles to the short axis length thereof is preferably in the range from 1 to 50, and, more preferably, from 1 to 20. It is preferable that the channel width is appropriately selected in accordance with the particle size and the particle shape.

The kind of the particles may be any one of the kinds listed below, but is not restricted thereto. For example, the kinds are organic crystals or aggregates such as polymer fine particles or pigment particles, inorganic crystals or aggregates, metal fine particles, and metal compound fine particles such as a metal oxide, a metal sulfide, and a metal nitride.

Specific examples of the polymer fine particles are fine particles of polyvinyl butyral resin, polyvinyl acetal resin, polyarylate resin, polycarbonate resin, polyester resin, phenoxy resin, polyvinyl chloride resin, polyvinylidene chloride resin, polyvinyl acetate resin, polystyrene resin, acrylic resin, methacrylic resin, styrene/acrylic resin, styrene/methacrylic resin, polyacrylamide resin, polyamide resin, polyvinyl pyridine resin, cellulose-based resin, polyurethane resin, epoxy resin, silicone resin, polyvinyl alcohol resin, casein, vinyl chloride/vinyl acetate copolymer, modified vinyl chloride/vinyl acetate copolymer, vinyl chloride/vinyl acetate/maleic anhydride copolymer, styrene/butadiene copolymer, vinylidene chloride/acrylonitrile copolymer, styrene/alkyd resin, and phenol/formaldehyde resin. Furthermore, the examples of the polymer fine particles may include a complex system in which various additive agents such as organic crystals or aggregates such as pigment particles, inorganic and inorganic crystals or aggregates, metal particles, metal compound particles such as a metal oxide, a metal sulfide, and a metal nitride are contained in such polymer fine particles, and composite system particles containing various additives such as a dispersing agent and an oxidation inhibitor.

Examples of the metal or metal compound fine particles include fine particles of: carbon black; a metal such as zinc, aluminum, copper, iron, nickel, chromium, titanium, and the like, or alloys thereof; metal oxides such as TiO₂, SnO₂, Sb₂O₃, In₂O₃, ZnO, MgO, iron oxide, and the like, or any compound thereof; metal nitrides such as silicon nitride, and the like; and any combination thereof.

Various methods of producing these fine particles may be used. In many cases, fine particles are produced by synthesis in medium liquid, and then subjected to classification as they are. Sometimes, fine particles may be produced by mechanically pulverizing a bulk material and then dispersing the resulting fine particles in medium liquid, followed by classification. In this case, the material is often pulverized in the medium liquid, and the resulting fine particles are classified directly.

In the case where powder (fine particles) which is produced in a dry process is to be classified, it is necessary to previously disperse the powder in medium liquid. An example of a method of dispersing the dry powder in the medium liquid is a method using a sand mill, a colloid mill, an attritor, a ball mill, a Dyno mill, a high-pressure homogenizer, an ultrasonic disperser, a co-ball mill, a roll mill or the like. In this case, it is preferable to perform the process under conditions where primary particles are not pulverized by the dispersion process.

Preferably, the difference which is obtained by subtracting the specific gravity of the medium liquid from that of the particles is 0.01 to 20, more preferably, 0.05 to 11, and, still more preferably, 0.05 to 4. When the difference which is obtained by subtracting the specific gravity of the medium liquid from that of the fine particles is equal to or larger than 0.01, the particles are satisfactorily sedimented, and hence this is preferred. By contrast, when the difference is equal to smaller than 20, the particles are easily transported, and hence this is preferred.

As the medium liquid, any medium liquid is preferably used as far as, as described above, the difference obtained by subtracting the specific gravity of the medium liquid from that of the particles is 0.01 to 20. Examples of the medium liquid are water, aqueous media, organic solvent type media, and the like.

The water may be ion-exchange water, distilled water, electrolytic ion water, or the like. Specific examples of the organic solvent type media are methanol, ethanol, n-propanol, n-butanol, benzyl alcohol, methylcellosolve, ethylcellosolve, acetone, methyl ethyl ketone, cyclohexanone, methyl acetate, n-butyl acetate, dioxane, tetrahydrofuran, methylene chloride, chloroform, chlorobenzene, toluene, xylene, and the like, and mixtures of two or more thereof.

A preferred example of the medium liquid varies depending on the kind of the particles. As preferred examples of the medium liquid for each kind of the particles, the medium liquid to be combined with polymer particles (the specific gravity thereof is generally from about 1.05 to 1.6) are aqueous solvents, organic solvents such as alcohols, xylene, and the like, acidic or alkaline waters, and the like which do not dissolve the particles.

Further, preferred examples of the medium liquid to be combined with the metal or metal compound fine particles (the specific gravity thereof is generally from about 2 to 10) are water, organic solvents such as alcohols, xylene and the like, and oils which do not oxidize or reduce to react with the metal or the like.

More preferred examples of combinations of the particles and the medium liquid are a combination of polymer particles and an aqueous medium, and that of a metal or a metal compound and a low-viscosity oily medium. Among examples, the combination of polymer fine particles and an aqueous medium is particularly preferable.

Preferable examples of the combination of the particles and the medium liquid are a combination of styrene/acrylic resin particles and an aqueous medium, that of styrene/methacrylic resin particles and an aqueous medium, and that of polyester resin particles and an aqueous medium.

The content rate of the particles in the particle dispersion is preferably from 0.01 to 40 vol. %, and, more preferably, from 0.05 to 25 vol. %. When the content rate of the particles in the particle dispersion is equal to or larger than 0.01 vol. %, the recovery is easily performed, and hence this is preferred. When the content rate is equal to or smaller than 40 vol. %, clogging of a channel is suppressed, and hence this is preferred.

In the exemplary embodiment, even in the case where a particle dispersion which has a relatively high particle concentration, and which is conventionally difficult to be classified is used, particularly, an excellent classification accuracy is obtained. Even in the case of a particle dispersion which has a content rate of 1.0 vol. % or more, and which is hardly classified by a conventional classifying method that uses a pinched channel or centrifugal force, particularly, the classification accuracy is excellent.

In the exemplary embodiment, the volume-average particle size of the particles is a value which is measured by using Coulter counter TA-II model (manufactured by Beckman Coulter, Inc.) except when the particles have the particle size described below (5 μm or less). In this case, the volume-average particle size is measured by using an optimum aperture depending on the particle size level of the particles. In the case where fine particles have a particle size of 5 μm or less, however, the volume-average particle size is measured by using a laser diffraction scattering particle size distribution measuring device (LA-920, manufactured by HORIBA, Ltd.).

The specific gravity of the particles is measured by using Ultrapycnometer 1000 manufactured by Yuasa Ionics Co., Ltd. by the gas phase displacement method (pycnometer method).

The specific gravity of the medium liquid is measured by using a specific gravity measuring kit AD-1653 manufactured by A & D Co., Ltd.

In the classifying apparatus of the exemplary embodiment, the transporting liquid is liquid not containing the particles to be classified. In the exemplary embodiment, preferably, the transporting liquid is identical with the medium liquid.

In the case where the transporting liquid is different from the medium liquid, moreover, the transporting liquid is preferably selected from the specific examples of the medium liquid described above.

Furthermore, a preferred mode of the specific gravity of the transporting liquid with respect to the particles is identical with the preferred mode of the specific gravity of the medium liquid with respect to the particles.

In the exemplary embodiment, preferably, the particle dispersion contains a surfactant in addition to the particles and the dispersion medium. A surfactant is adsorbed to the surfaces of the particles in the particle dispersion to exert a function of forming and stabilizing fine particles, and preventing these particles from again aggregating. Moreover, a surfactant has an effect of preventing the particles from electrostatically adhering to the inner wall face of the channel in the classifying apparatus. Therefore, the use of a surfactant is preferred

Examples of the surfactant are a cationic surfactant, an anionic surfactant, and a nonionic surfactant. In the exemplary embodiment, the surfactant is not particularly restricted, and it is preferable that the surfactant is appropriately selected in accordance with the particles.

Examples of the cationic surfactant are a quaternized ammonium salt, polyamine alkoxylate, aliphatic amine polyglycol ether, an aliphatic amine, diamine and polyamine derived from an aliphatic amine and aliphatic alcohol, imidazoline derived from a fatty acid, and salts of cationic materials of these surfactants. These cationic dispersing agents may be used alone or as combination of two or more kinds thereof.

Examples of the anionic surfactant are an N-acyl-N-methyltaurine salt, a fatty acid salt, an alkyl sulfate salt, an alkyl benzene sulfonate salt, an alkyl naphthalene sulfonate salt, a dialkyl sulfosuccinate salt, an alkyl phosphate salt, a naphthalene sulfonate formaldehyde condensate, and a polyoxyethylene alkyl sulfate salt. Among the anionic surfactants, an N-acyl-N-methyltaurine salt and a polyoxyethylene alkyl sulfate salt are preferred. Preferably, a cation for forming a salt is an alkali metal cation. These dispersing agents may be used alone or as combination of two or more kinds thereof.

Examples of the nonionic surfactant are a polyoxyethylene alkyl ether, a polyoxyethylene alkyl aryl ether, a polyoxyethylene fatty acid ester, a sorbitan fatty acid ester, a polyoxyethylene sorbitan fatty acid ester, a polyoxyethylene alkyl amine, and a glycerin fatty acid ester. Among the nonionic surfactants, a polyoxyethylene alkyl ether is preferred. These nonionic surfactants may be used alone or as combination of two or more kinds thereof.

Among the surfactants, in the case where a resin fine particle dispersion is used as the particle dispersion, an anionic surfactant is preferably used, and, more preferably, an N-acyl-N-methyltaurine salt, a fatty acid salt, an alkyl sulfate salt, an alkyl benzene sulfonate salt, an alkyl naphthalene sulfonate salt, a polyoxyethylene alkyl sulfate salt, and the like are used.

The addition amount of a surfactant is not particularly restricted. In order to further improve the uniform dispersibility of the particles, however, the addition amount is preferably 0.0001 to 20 wt. % of the whole solid content of the particle dispersion, more preferably, 0.001 to 10 wt. %, and, still more preferably, 0.005 to 5 wt. %.

### EXAMPLES

### Example 1

A classifying device such as shown in FIG. 1 is produced. As the substrates, two acrylic resin plates of (height) 40 mm×(width) 200 mm×(thickness) 8 mm are used. In the plates, channels which are bilaterally symmetric are cut by an end mill. The plates are bonded and screwed together to produce the classifying device.

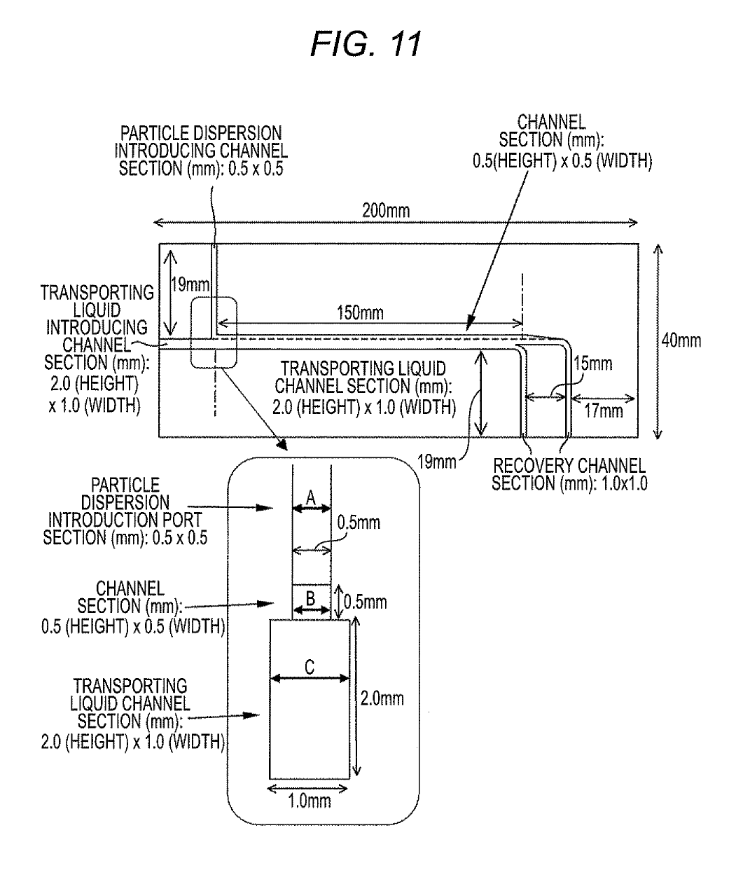

In the device, a channel of a width of 0.5 mm× a height of 0.5 mm is disposed in an upper portion of a classifying channel in a classifying zone. FIG. 1 is a schematic perspective view of the classifying apparatus, and FIG. 11 is a view in which the dimensions are indicated.

The particle dispersion and water are transported by using a syringe pump (PHD 2000 manufactured by Harvard Apparatus). In order to prevent particles from being sedimented in the syringe, the classifying device is set in a state where the inclination angle θ is 45° as shown in FIG. 9. A small stirring element is disposed in the syringe, and the liquid transportation is performed while the stirring element is rotated from the outside of the syringe by a magnetic stirrer.

In FIG. 11, the width means the length of the channel in a direction perpendicular to the transportation direction of the particle dispersion in the classifying channel, and in the horizontal direction, and the height means the length of the channel in a direction perpendicular to the transportation direction of the particle dispersion in the classifying channel, and perpendicular to the width. The length means the length of the channel in the flowing direction. In the case where, as in the particle dispersion introducing channel and the recovery channels, the transportation direction extends in the vertical direction, they are defined in a different manner. The same shall apply in the following examples and comparative examples.

A separation test is performed by using resin particles (Soken Kagaku K.K., cross-linked acrylic particles MX-300 and MX1500H having a density of 1.19 g/cm³). First, acrylic resin particles of 3 μm and 15 μm are dispersed in water at a mixture ratio of 50:50 (weight parts), and then 0.05 weight parts of dodecyl sodium sulfate are added as a surfactant to prepare particle dispersion A having a solid content concentration of 3%. The particle dispersion A and water B are transported at a flow ratio A:B of 2:60 (ml/h) by using the classifying device. Then, it is confirmed that, in the recovered liquid from branched recovery channel 2, particles of 15 μm are removed, only particles of about 3 μm are recovered, and separation between particles of 3 μm and particles of 15 μm is enabled.

### Comparative Example 1

A classifying device in which a channel such as shown in FIG. 4 is not disposed is produced. The classifying device is produced in the same manner as Example 1 except that the channel is not disposed, and a separation test for resin particles is performed.

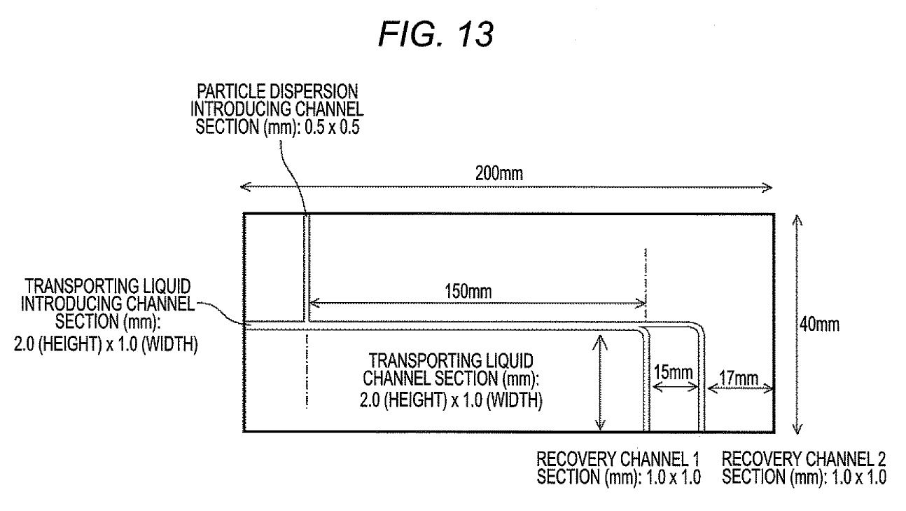

FIG. 4 is a schematic view of the classifying apparatus, and FIG. 13 is a view in which the dimensions are indicated.

The dispersion A and water (transporting liquid) B are transported at a flow ratio A:B of 2:40 (ml/h) by using the above-described classifying device in a state where the device is inclined by 45° in the same manner as FIG. 9. Then, it is confirmed that 1.9 vol. % of particles of 15 μm or more are incorporated in the recovered liquid from the branched recovery channel 2, and the effect of separation between particles of 3 μm and particles of 15 μm is slightly lowered as compared with Example 1.

### Example 2

A classifying process is performed in the same manner as Example 1 except that the inclination angle θ is set to 0° as shown in FIG. 8. The classifying process is continuously performed for 3 hours. It is confirmed that clogging of the channel does not occur, particles of 15 μm in the recovered liquid from the recovery channel 2 are removed, and a continuous process of separating particles of 3 μm and particles of 15 μm from each other is enabled.

### Comparative Example 2

A continuous classifying process is performed in the same manner as Comparative example 1 except that the inclination angle θ of the classifying device is set to 0° as shown in FIG. 8. When the classifying process is continued, clogging of the channel occurs after an elapse of 60 minutes, and the continuous classifying process is difficult to perform.

### Example 3

A classifying process is performed on particle dispersion C (having a composition ratio of 75:25, and an average molecular weight of 35,000) of styrene-n-butyl acrylate resin. The density of the resin is 1.08 g/cm³. Particles having average particle size of 5 μm, 10 μm, and 20 μm are mixed with each other at a volume ratio of 8:1:1. Then, 0.05 weight parts of dodecyl sodium sulfate are added as a surfactant, and the resulting mixture is dispersed in ion-exchange water to prepare resin particle dispersion C having a solid content concentration of 5.0%. Particle size distribution data of the resin particle dispersion C which are measured by Coulter counter TA-II model show a particle size distribution having a large peak at 5 μm, and two small peaks at 10 μm and 20 μm.

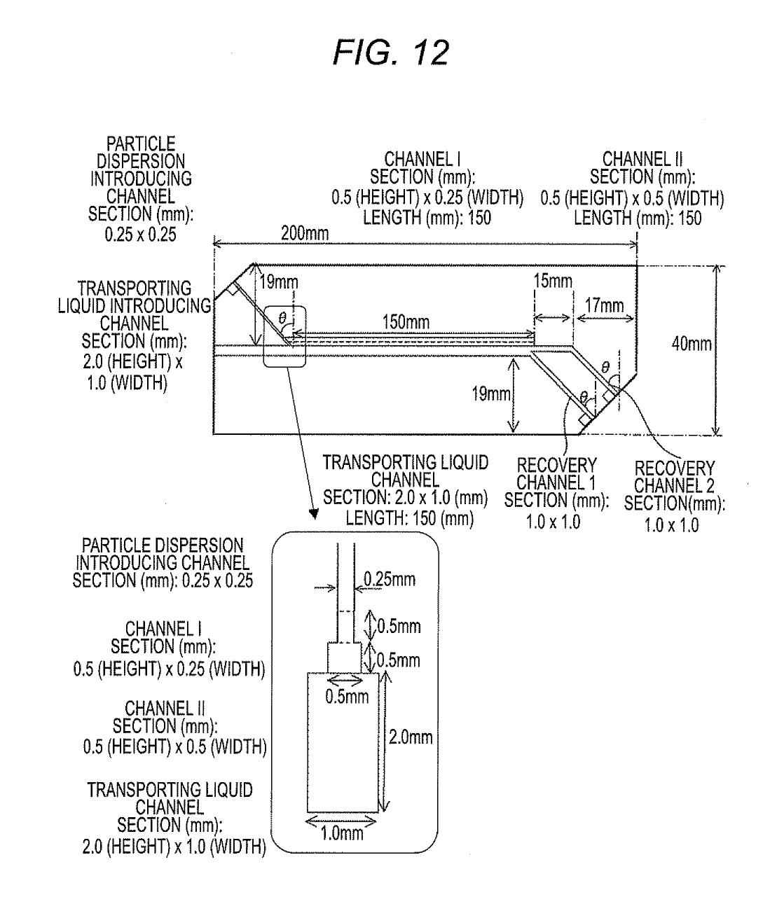

A classifying process is performed on the resin particle dispersion C by using a classifying device in which a particle dispersion channel having the two-step structure shown in FIG. 7 is used, in a state where the device is inclined by 45° as shown in FIG. 10. FIG. 12 shows the dimensions. The particle size distribution of the fine particle recovery liquid in FIG. 10 is measured by Coulter counter TA-II model. The result of the measurement shows a particle size distribution in which there is no particle peak at 20 μm, and which has two particle peaks, or a small peak at 10 μm, and a large peak at 5 μm.

### Example 4

A classifying process is performed in the same manner as Example 3 except that, in place of 0.05 weight parts of dodecyl sodium sulfate which is used as a surfactant in Example 3, 0.10 weight parts of N-oleoyl-N-methyltaurin sodium salt is used in the particle dispersion C of styrene-n-butyl acrylate resin. The particle size distribution of the fine particle recovery liquid in FIG. 10 is measured by Coulter counter TA-II model. The result of the measurement shows a particle size distribution in which there is no particle peak at 20 μm, and which has two particle peaks, or a small peak at 10 μm, and a large peak at 5 μm.

### Comparative Example 3

A classifying process is performed by using the classifying device of FIG. 4 in which the particle dispersion channel used in Comparative example 1 is not disposed, on the particle dispersion C of styrene-n-butyl acrylate resin used in Example 3, in a state where the device is inclined by 45° as shown in FIG. 9. The particle size distribution of the recovery liquid recovered from the recovery channel 2 is measured by Coulter counter TA-II model. As a result, it is confirmed that the content of particles of 15 μm or more is 2.9 vol. %, the result of the measurement shows a particle size distribution having a large peak at 5 μm, and two small peaks at 10 μm and 20 μm, and the separation effect is slightly lowered as compared with Example 3.

### Example 5

A classifying process is performed in the same manner as Example 3 except that dodecyl sodium sulfate is not added, on the particle dispersion C of styrene-n-butyl acrylate resin. The particle size distribution of the fine particle recovery liquid in FIG. 10 is measured by Coulter counter TA-II model. As a result, it is confirmed that the content of particles of 15 μm or more is 2.8 vol. %, a particle size distribution has a very small peak at 20 μm, and, since a surfactant is not added, the separation effect is slightly lowered as compared with Example 3.

TABLE 1

| | Recovery | | Recovery | | |
|---|---|---|---|---|---|
| | channel 1 | | channel 2 | | |
| | (vol. %) | | (vol. %) | | |
| | 15 μm | 15 μm | 15 μm | 15 μm | |
| | or less | or more | or less | or more | Remarks |
| Example 1 | 30.7 | 69.3 | 100 | 0 | |
| Example 2 | 31.5 | 68.5 | 100 | 0 | Continuously |
| | | | | | used for |
| | | | | | 3 hours |
| Example 3 | 21.6 | 78.4 | 99.4 | 0.6 | |
| Example 4 | 20.9 | 79.1 | 99.6 | 0.4 | |
| Example 5 | 24.3 | 75.7 | 97.2 | 2.8 | |
| Comparative | 34.6 | 65.4 | 98.1 | 1.9 | |
| example 1 | | | | | |
| Comparative | 38.2 | 61.8 | 95.4 | 4.6 | Clogging |
| example 2 | | | | | occurs after |
| | | | | | 60 minutes |
| Comparative | 41.3 | 58.7 | 97.1 | 2.9 | |
| example 3 | | | | | |

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A classifying apparatus comprising:
a classifying channel that, in an upper portion, has a channel through which a particle dispersion is transported, and that, in a lower portion, has a channel through which transporting liquid is transported;
a particle dispersion introducing channel where one end has an opening into which the particle dispersion is introduced, and another end is connected to the channel through which the particle dispersion is transported;
a transporting liquid introducing channel where one end has an opening into which the transporting liquid is introduced, and another end is connected to the channel through which the transporting liquid is transported; and
at least one recovery channel where one end has an opening, and another end is connected to the classifying channel to recover classified particles,
a channel width of the channel through which the particle dispersion is transported being smaller than a channel width of the channel through which the transporting liquid is transported, in the classifying channel.

2. The classifying apparatus according to claim 1, wherein, when a channel width of the particle dispersion introducing channel is indicated by A, the channel width of the channel through which the particle dispersion is transported is indicated by B, and the channel width of the channel through which the transporting liquid is transported, in the classifying channel is indicated by C, A, B, and C satisfy following Expression (1):
A≦B<C (1).

3. The classifying apparatus according to claim 2, wherein B<C in the Expression (1) holds at least in a most upstream of the channel through which the particle dispersion is transported.

4. The classifying apparatus according to claim 2, wherein the channel width B is about 1 to about 2,500 μm.

5. The classifying apparatus according to claim 2, wherein the channel width B is smaller than the channel width C, equal to or larger than about 1/100 of the channel width C, and equal to or smaller than about ⅔ of the channel width C.

6. The classifying apparatus according to claim 2, wherein the channel width A is about 0.1 to about 1 time of the channel width B.

7. The classifying apparatus according to claim 1, wherein the channel through which the particle dispersion is transported has a height of about 1 to about 2,000 μm.

8. The classifying apparatus according to claim 1, wherein a length of the channel through which the particle dispersion is transported is indicated by Lb, and a length of a classifying portion of the classifying channel is indicated by Lc, following Expression (2) is satisfied:
0.1×Lc≦Lb≦Lc (2).

9. The classifying apparatus according to claim 8, wherein Lb is about 0.15 to about 0.95 times of Lc.

10. The classifying apparatus according to claim 1, wherein a vicinity of a downstream terminal end of the channel through which the particle dispersion is transported is tapered.

11. The classifying apparatus according to claim 2, wherein the channel through which the particle dispersion is transported has a multi-step structure, and a channel width BI of a channel I which is directly connected to the particle dispersion introducing channel, and through which the particle dispersion is transported, a channel width BI of a second-step channel BII through which the particle dispersion is transported, and which is disposed below the channel I through which the particle dispersion is transported, and a channel width Bn of an n-th-step channel n through which the particle dispersion is transported satisfy following Expression (3):
A≦BI<BII< . . . <Bn<C (3).

12. The classifying apparatus according to claim 1, wherein a flow rate of the particle dispersion in the particle dispersion introducing channel is about 0.001 to about 500 mL/hr.

13. The classifying apparatus according to claim 1, wherein a flow rate of the transported liquid in the transporting liquid introducing channel is about 0.002 to about 5,000 mL/hr.

14. The classifying apparatus according to claim 1, wherein the classifying channel has an inclination of an angle of larger than 0° and smaller than about 90° with respect to a horizontal direction, and a liquid transportation direction in at least one of the particle dispersion introducing channel and the recovery channel extends from an upper side in a vertical direction toward a lower side.

15. A classifying method wherein particles in a particle dispersion is classified with the classifying apparatus according to claim 1.

16. The classifying method according to claim 15, wherein at least one of a surfactant and a pH adjusting agent is contained in the particle dispersion.
